(19) United States
(12) Patent Application Publication
(10) Pub. No.: US 2026/0340072 A1
(43) Pub. Date: Oct. 29, 2026

(54) Recognition-Geometry Gravity Kernel Solver: Methods and Hardware for Parameter-Free Fractional-Order Gravitational Potential Computation Using a Fixed Softened Fractional Kernel

(71) Applicant: Jonathan Washburn, Austin, TX (US)

(72) Inventor: Jonathan Washburn, Austin, TX (US)

(21) Appl. No.: 19/654,910

(22) Filed: Apr. 22, 2026

Related U.S. Application Data
(60) Provisional application No. 63/794,503, filed on Apr. 25, 2025.

(51) Int. Cl. G06F 17/14

(52) U.S. Cl. CPC G06F 17/14

(57) ABSTRACT

A parameter-free gravitational-potential solver computes gravitational potential from a mass-density representation using a fixed softened fractional Fourier-domain kernel K(k)=1/(|k|∧2+k0∧2)∧(5/12), where k0=pi/phi and phi=(1+sqrt(5))/2. A density representation is transformed into reciprocal space, multiplied by the fixed kernel, and transformed back to generate a gravitational potential field. Optional spectral derivatives generate gravitational acceleration outputs. In preferred embodiments, the kernel is realized using a radially indexed lookup structure with precomputed values, and the solver is implemented on software, GPU, FPGA, CPU, ASIC, or hybrid computing platforms. The exponent 5/12 and the softening scale k0 are fixed and are not fitted to data.

### CROSS-REFERENCE TO RELATED APPLICATION

This application claims priority to U.S. Provisional Patent Application No. 63/794,503, filed Apr. 25, 2025, the disclosure of which is incorporated herein by reference in its entirety to the extent permitted by law.

### BACKGROUND

The present disclosure relates to numerical simulation and computation of gravitational fields and gravitational potentials, including applications in astrophysics, geodesy, inertial navigation, gravity anomaly analysis, and related computational physics environments. More particularly, the present disclosure relates to parameter-free fractional-order gravitational potential computation using a fixed softened fractional kernel and corresponding software, firmware, and hardware implementations. The disclosed subject matter further relates to high-performance numerical computing architectures including transform-domain solvers, lookup-memory kernel realization, GPU accelerators, FPGA accelerators, and embedded real-time gravitational-field computation.

Observed galactic rotation curves remain substantially flat at radii beyond the visible baryonic mass distribution, whereas conventional Newtonian gravity predicts a Keplerian decline in which orbital velocity decreases approximately as r∧(−1/2). This mismatch has long motivated the introduction of dark matter halo models and alternative gravity frameworks. Representative alternative approaches include Modified Newtonian Dynamics (MOND), f(R) gravity, emergent-gravity frameworks, Yukawa-type modifications, and softened-kernel approaches. However, such approaches generally introduce one or more empirical parameters, fitting scales, interpolation functions, or user-selected numerical settings that must be tuned for a given galaxy, dataset, simulation environment, or solver implementation.

Related computational methods also exist for solving Poisson equations and fractional differential equations in gravitational and non-gravitational contexts. Conventional Newtonian gravitational solvers generally apply a 1/|k|∧2 Fourier-domain kernel or equivalent real-space Green's-function methods. Other approaches use softened kernels such as Plummer softening or Yukawa-type screening, but such approaches likewise typically rely on adjustable empirical softening parameters. Generic fractional Laplacian solvers are also known, but such solvers ordinarily treat the fractional exponent and any softening or regularization term as user-specified inputs, numerical hyperparameters, or tunable model quantities rather than as fixed quantities determined in advance.

These limitations are not confined to astrophysical modelling. Accurate gravitational-potential computation is also important in geodesy, where residual error in geoid recovery can degrade datum refinement and gravity-field interpretation; in inertial navigation, where terrain-induced gravity variations can affect long-duration navigation drift; in gravity anomaly analysis, where recovery of subsurface density structure may depend on stable and computationally efficient inversion kernels; and in simulation environments, where practical real-time or near-real-time gravitational computation may be desirable. In these contexts, the use of tunable or empirically selected kernel parameters can complicate interpretation, increase calibration burden, reduce reproducibility, and limit deployment across distinct platforms.

Existing fractional and modified-gravity computational approaches do not provide a gravity solver that combines a fixed exponent of 5/12, a fixed softening scale k0=pi/phi, a parameter-free kernel definition, a practical transform-domain implementation of that kernel, and a hardware-oriented pre-tabulated realization suitable for accelerated execution. There accordingly remains a need for a computational gravity architecture in which the kernel-defining quantities are fixed and fully determined, rather than selected or tuned, while still permitting practical implementation in transform-domain numerical pipelines and in accelerated hardware environments. There further remains a need for a gravitational solver that regularizes low-frequency behavior, avoids infrared divergence at k=0, remains compatible with lookup-memory realization and hardware acceleration, and provides a concrete make-and-use pathway across software and hardware implementations without requiring empirical fitting of the core kernel-defining quantities.

### SUMMARY

The present disclosure provides a parameter-free gravitational-potential solver that computes gravitational potential from a mass-density representation by applying a fixed softened fractional Fourier-domain kernel. In particular, the solver implements a kernel K(k)=1/(|k|∧2+k0∧2)∧( 5/12), in which the exponent is fixed at 5/12 and the softening scale is fixed at k0=pi/phi. Neither 5/12 nor k0 is fitted. Rather, both are fixed and fully determined for purposes of the disclosed solver architecture.

In one aspect, the disclosure provides a computer-implemented method in which a mass-density representation is received, transformed into reciprocal space, multiplied by the fixed kernel, and transformed back to produce a gravitational potential field. In preferred implementations, the transform is a forward Fourier transform, the reciprocal-space multiplication is a pointwise multiplication by the fixed kernel, and the return transform is an inverse Fourier transform. The resulting solver provides a practical make-and-use pathway for gravitational-potential computation using a fixed softened fractional operator rather than a tunable empirical kernel.

In another aspect, the disclosure provides system and hardware architectures configured to perform the same fixed-kernel gravitational solve. Such architectures can include software-executed implementations, GPU-accelerated implementations, FPGA-based implementations, embedded implementations, and other compute platforms capable of carrying out the disclosed reciprocal-space kernel application. In preferred embodiments, the kernel is pre-tabulated in memory, such as a lookup table or ROM structure, so that runtime kernel recomputation is reduced or avoided.

In a further aspect, the disclosure provides optional output branches in which one or more acceleration components are derived from the computed gravitational potential. In such embodiments, spectral derivatives may be applied in reciprocal space to obtain one or more components of gravitational acceleration, which may then be transformed back to physical space. These derivative outputs are optional and need not be required in all implementations.

In certain preferred embodiments, the disclosed solver is implemented as a transform-domain pipeline including a density-ingress stage, a reciprocal-space transform stage, a fixed-kernel retrieval stage, a reciprocal-space multiplication stage, and an inverse transform stage. In selected embodiments, the solver further includes interpolation logic for retrieving kernel values from a precomputed radial lookup table, precision-mode selection logic, distributed execution logic, or derivative-output logic. Such features may improve performance, portability, or deployment flexibility, but do not alter the core identity of the invention as a fixed-kernel parameter-free gravitational solver.

In certain embodiments, the kernel is realized using a radially indexed lookup structure based on the magnitude |k|. In selected implementations, the kernel values are computed prior to runtime, for example at synthesis time, initialization time, compile time, startup time, or another precompute stage, and thereafter applied during runtime gravitational solves. This arrangement is particularly well suited for accelerated implementations, including memory-based GPU and FPGA pipelines.

In certain embodiments, the disclosed solver may be applied in astrophysical modelling, geoid recovery, inertial navigation, gravity anomaly analysis, subsurface-density analysis, spacecraft navigation, simulation environments, or related gravitational-field computation contexts. Such use cases are downstream applications of the disclosed fixed-kernel solver architecture and do not redefine the core invention.

In certain embodiments, formal verification and machine-checked support may be used to confirm one or more properties of the disclosed solver architecture, including that the exponent is fixed, that the softening scale is fixed, that the kernel is positive, that the kernel remains finite at zero frequency, that the architecture is parameter-free with respect to the kernel-defining quantities, and that compact lookup-memory realization is available. Such formal support reinforces the internal coherence of the disclosed architecture and provides additional support for implementation and claim strategy.

In certain embodiments, the disclosed solver is validated against one or more empirical benchmarks, such as galaxy rotation-curve residuals, geoid-recovery residuals, numerical precision comparisons, interpolation error targets, throughput measurements, or timing measurements. Such results are empirical outputs and validation results, not theoretical guarantees, but they demonstrate that the disclosed fixed-kernel architecture can be implemented in practical computational systems.

In certain embodiments, the disclosure further preserves alternative numerical implementations that apply the same fixed kernel using numerical engines other than the preferred transform-domain pipeline, including tree-based, adaptive-mesh, spectral-element, CPU-based, or other reciprocal-space computational realizations. These embodiments preserve the same fixed kernel and therefore remain within the disclosed inventive architecture, while providing fallback support for future claim drafting and implementation flexibility.

In certain embodiments, the disclosed solver implements a static gravitational kernel architecture that can serve as a computational component in broader modelling environments. However, the present disclosure is directed to the fixed-kernel gravitational solver itself. To the extent broader time-dependent cosmological extensions are contemplated, such extensions may employ additional structures beyond the static fixed-kernel architecture disclosed herein.

### BRIEF DESCRIPTION OF THE FIGURES

FIG. 1 is a schematic diagram of an overall gravity kernel solver architecture centered on a fixed-kernel gravitational-potential computation pipeline.

FIG. 2 is a schematic diagram showing the fixed kernel definition, the fixed exponent, the fixed softening scale, and representative kernel properties.

FIG. 3 is a flow diagram showing a transform-domain computation workflow for generating gravitational potential from a mass-density representation.

FIG. 4 is a diagram showing reciprocal-space kernel behavior and a corresponding lookup-memory realization for the fixed kernel.

FIG. 5 is a schematic diagram of a GPU-based implementation of the disclosed fixed-kernel gravitational solver.

FIG. 6 is a schematic diagram of an FPGA-based implementation of the disclosed fixed-kernel gravitational solver.

FIG. 7 is a schematic diagram showing representative output products, including gravitational potential output and optional derivative-based acceleration outputs.

FIG. 8 is a schematic diagram showing alternative numerical embodiments that preserve application of the same fixed kernel.

FIG. 9 is a flow diagram showing a validation and acceptance workflow for benchmarking and evaluating the disclosed solver.

FIG. 10 is a schematic diagram showing formal-support and verification architecture associated with the disclosed solver.

FIG. 11 is a schematic diagram showing representative downstream deployment contexts for the disclosed solver.

FIG. 12 is a schematic diagram showing a boundary between the disclosed static fixed-kernel solver architecture and future time-dependent gravitational-kernel extensions.

### DETAILED DESCRIPTION

The present disclosure provides a parameter-free gravitational-potential solver that computes gravitational potential from a mass-density representation by applying a fixed softened fractional Fourier-domain kernel. The solver implements a kernel K(k)=1/(|k|∧2+k0∧2)∧(5/12), where the exponent is fixed at 5/12 and the softening scale is fixed at k0=pi/phi. Neither 5/12 nor k 0 is fitted. Rather, both are fixed and fully determined for purposes of the disclosed solver architecture.

In its core form, the disclosed solver receives a representation of mass density over a computational domain, transforms that representation into reciprocal space, applies the fixed kernel in reciprocal space, and transforms the result back to produce gravitational potential in physical space. In preferred embodiments, the transformation into reciprocal space is a forward Fourier transform, the kernel application is a pointwise reciprocal-space multiplication, and the return transformation is an inverse Fourier transform. However, as described further below, other numerical engines may be used while preserving application of the same fixed kernel.

The invention should be understood as centered on the fixed-kernel gravitational solve itself. Hardware platforms, precision modes, output branches, deployment environments, and downstream applications may vary from implementation to implementation, but such variations do not alter the core identity of the invention as a fixed-kernel, parameter-free gravitational-potential solver.

As used herein, rho(r) refers to a mass-density field, grid, distribution, or other spatial representation of source mass over a computational domain. The variable r denotes a spatial coordinate in physical space.

As used herein, rho_tilde(k) refers to the reciprocal-space representation of rho(r), whether generated by a Fourier transform or by another reciprocal-space mapping or spectral representation. The variable k denotes a reciprocal-space coordinate, and |k|denotes the magnitude of the reciprocal-space coordinate.

As used herein, Phi(r) refers to a gravitational potential field produced from the mass-density representation, and Phi_tilde(k) refers to the reciprocal-space representation of the gravitational potential field.

As used herein, g refers to gravitational acceleration, which may be represented as a vector field in physical space. In selected embodiments, one or more components of g may be computed from Phi by differentiation in reciprocal space followed by one or more inverse transforms.

As used herein, k0 refers to the fixed softening wave number used in the disclosed kernel. In the disclosed architecture, k0 is fixed at pi/phi, and is equivalently expressed as 1/Xopt, where Xopt denotes an optimal recognition scale used to define the fixed softening quantity.

As used herein, phi refers to the golden ratio, namely phi=(1+sqrt(5))/2.

As used herein, normalized reciprocal-length units refers to the reciprocal-space coordinate system used internally by the solver. In such units, the quantities |k|and k0 are represented in solver coordinates associated with the chosen grid spacing, domain scale, or discretization of the computational domain. Conversion between solver coordinates and physical units may be performed according to the selected domain discretization.

In one aspect, the disclosed solver evaluates a fractional gravitational relation of the form:

(k0∧2−del∧2)∧(5/12)Phi=−4 pi G rho

In reciprocal space, the foregoing relation is implemented using the fixed kernel:

K(k)=1/(|k|∧2+k0∧2)∧(5/12)

The reciprocal-space potential may accordingly be expressed as:

Phi_tilde(k)=−4 pi G K(k) rho_tilde(k)

This is the kernel that the solver implements.

The fixed softening scale is:

k0=1/Xopt=pi/phi

The exponent 5/12 and the softening scale k0=pi/phi are both fixed. Neither quantity is selected at runtime as a user-adjustable model parameter, and neither quantity is fitted to a target dataset in order to define the kernel used by the disclosed solver.

The fixed exponent 5/12 and the fixed softening quantity k0 are not arbitrary numerical settings selected from a tunable family of softened or fractional kernels. Rather, these quantities are integral to the disclosed recognition-geometry framework underlying the solver and define the particular gravitational kernel architecture implemented herein. Accordingly, the disclosed solver is not a generic fractional solver with user-adjustable kernel parameters, but a specific fixed-kernel computational architecture in which the exponent and softening quantity are part of the identity of the invention.

In the disclosed architecture, the fractional exponent is fixed at 5/12. This value is not a tunable fractional-order choice and is not provided as a free input for model fitting. Instead, the fixed exponent is part of the definition of the disclosed solver and is preserved across disclosed software, firmware, and hardware realizations.

In the disclosed architecture, the exponent 5/12 arises from the Recognition-Physics gravity cascade. More particularly, the fractional-order correction is associated with the curvature extremum of the J-cost functional at the recognition length scale, such that the gravitational channel is represented by the fixed rational exponent 5/12 rather than by a user-selected fractional order.

In preferred implementations, the fixed exponent may be represented exactly as a rational quantity, namely 5/12. Exact rational representation may simplify implementation in fixed-point logic, lookup-table generation, hardware synthesis flows, or other environments in which exact parameter retention is preferable to floating-point approximation during design-time processing.

In preferred implementations, representation of the exponent as an exact ratio of small integers supports efficient fixed-point realization, lookup-table generation, ROM-based kernel storage, and hardware synthesis workflows in which exact retention of the kernel-defining quantities is advantageous.

Because the exponent is fixed, the disclosed solver differs from generic fractional differential solvers in which the fractional order is entered, selected, estimated, or tuned by a user. The disclosed solver is therefore not merely an example of a fractional solver, but rather a specific fixed-order gravitational solver architecture.

In the disclosed architecture, the softening scale is fixed at k0=pi/phi. This quantity is equivalently expressed as 1/Xopt and is not an empirical softening parameter of the type commonly introduced in softened Newtonian or screened-kernel approaches.

In the disclosed architecture, the softening wave number k0 is the reciprocal of the optimal recognition scale Xopt and is given by k0=1/Xopt=pi/phi, which is approximately 1.941 in normalized reciprocal-length units.

The fixed softening scale regularizes the kernel at low reciprocal-space magnitude and avoids divergence at k=0. More specifically, the denominator term (|k|∧2+k0∧2) remains finite at |k|=0, so that the kernel value at zero frequency is also finite.

The fixed softening scale also defines a transition region between a low-|k|softened regime and a higher-|k|regime. In selected implementations, this transition may be used to guide lookup-table density, interpolation fidelity, precision selection, or domain-specific analysis of solver behavior, but the value of k0 itself remains fixed.

In normalized units, the corresponding transition radius may be expressed as r 0=2pi/k0 , which is approximately 2 phi, or approximately 3.236, thereby providing a representative scale for the transition between the low-|k|softened regime and the higher-|k|regime.

In physical deployments, the numerical interpretation of k0 in SI or other physical units may depend on the discretization of the computational grid, the selected domain scale, or other coordinate-mapping conventions. However, such mapping does not alter the fact that the kernel-defining softening quantity is fixed within the solver architecture.

The disclosed fixed kernel has a number of computationally useful properties.

First, the kernel is positive for all valid reciprocal-space magnitudes. This avoids sign-changing kernel behavior and simplifies reciprocal-space multiplication.

Second, the kernel decreases with increasing |k|. Accordingly, the kernel is largest at low reciprocal-space magnitude and smaller at higher reciprocal-space magnitude.

Third, the kernel remains finite at |k|=0 because of the presence of the fixed softening term k0∧2 in the denominator.

In particular, the kernel value at zero reciprocal-space magnitude is K(0)=1/k0∧(5/6), thereby confirming that the origin is softened and that no infrared divergence occurs at k=0.

Fourth, for sufficiently large |k|relative to k0, the kernel approaches a high-|k|power-law behavior corresponding to the disclosed fixed exponent.

For sufficiently large |k|relative to k0, the kernel approaches K(k) approximately equal to 1/|k|∧(5/6), corresponding to the disclosed fixed fractional-order behavior.

Fifth, the kernel is real-valued and symmetric with respect to reciprocal-space magnitude, which makes the kernel particularly suitable for radial lookup-table realization indexed by |k|.

These properties contribute to computational practicality. A positive, finite, monotonic, real-valued kernel can be precomputed, stored compactly, interpolated predictably, and applied efficiently in reciprocal-space computational flows.

Conventional Newtonian gravitational solvers generally apply a reciprocal-space kernel proportional to 1/|k|∧2. Other softened approaches, such as Plummer-style softening and Yukawa-style screening, typically introduce one or more empirical softening or screening parameters. Generic fractional solvers likewise generally permit a user to choose the fractional exponent and any associated regularization quantity.

By contrast, the disclosed solver implements a specific fixed kernel with a fixed exponent of 5/12 and a fixed softening scale of pi/phi. The kernel-defining quantities are not runtime-selected and are not fitted to observations in order to define the solver kernel. In this sense, the disclosed solver is parameter-free with respect to the kernel-defining quantities.

The disclosed solver further differs from generic mathematical formulations by providing a concrete make-and-use architecture suitable for high-performance implementation, including transform-domain execution, lookup-memory kernel realization, GPU execution, FPGA execution, and other fixed-kernel computational pipelines.

In preferred embodiments, the solver receives a density grid representing mass distribution over a finite computational domain. The grid may be one-dimensional, two-dimensional, or three-dimensional, although three-dimensional grid realizations are preferred for many gravitational applications.

The mass-density representation may be derived from observational data, simulated data, transformed data, interpolated data, or combinations thereof. Non-limiting examples include baryonic density maps, surface-density maps, volumetric density reconstructions, gravity anomaly grids, terrain-referenced density models, and synthetic simulation grids.

In selected embodiments, the input may further include metadata such as grid spacing, domain scale, coordinate origin, numerical precision mode, output-mode selection, acceleration-output selection, or target deployment mode. Such metadata may be used to configure execution, but does not alter the fixed kernel itself.

In preferred implementations, the input density representation is loaded into system memory, device memory, or another accessible computational storage structure. One or more execution plans may then be prepared for performing reciprocal-space transformation and inverse transformation.

In transform-domain embodiments, solver setup may include preparation of a forward Fourier transform plan, an inverse Fourier transform plan, allocation of intermediate reciprocal-space buffers, initialization of kernel lookup storage, and selection of any desired precision mode or execution mode.

In selected embodiments, reciprocal-space coordinates are normalized according to the chosen grid size, domain dimensions, and discretization spacing. The resulting reciprocal-space coordinates may then be used to retrieve or compute kernel values corresponding to each reciprocal-space location.

In preferred embodiments, kernel values are not freshly derived from a fitted parameter set at runtime. Instead, because the exponent and softening scale are fixed, kernel values may be precomputed and stored, generated at initialization, or otherwise made available in a fixed-kernel realization suitable for repeated application across many solve operations.

In one preferred method, a gravitational potential is computed according to the following sequence.

In a first stage, a mass-density representation rho(r) is received or loaded.

In a second stage, the density representation is transformed into reciprocal space to obtain rho_tilde(k).

In a third stage, one or more values of the fixed kernel K(k) are retrieved, interpolated, generated from precomputed data, or otherwise provided for reciprocal-space locations of interest.

In a fourth stage, the transformed density representation is multiplied by the fixed kernel in reciprocal space. In preferred embodiments, the multiplication is pointwise. A scaling factor, such as −4 pi G, may also be applied at this stage.

In a fifth stage, the reciprocal-space potential representation Phi_tilde(k) is transformed back into physical space.

In a sixth stage, a gravitational potential field Phi(r) is output, stored, displayed, transmitted, or provided to a downstream consumer module.

In preferred transform-domain embodiments, the foregoing sequence may be implemented as a forward FFT, reciprocal-space multiply, and inverse FFT pipeline. However, the broader inventive concept is the application of the fixed disclosed kernel to compute gravitational potential from mass density, and not merely the use of any one transform library or hardware platform.

In preferred three-dimensional transform-domain embodiments, the computational complexity is dominated by the transform stages and scales as O(N∧3 log N) for a grid of side length N. The reciprocal-space kernel multiplication scales as O(N∧3), so the overall transform-domain solve remains O(N∧3 log N).

In selected embodiments, one or more components of gravitational acceleration may be derived from the computed gravitational potential. In such embodiments, spectral derivatives may be applied in reciprocal space so that one or more reciprocal-space acceleration components are obtained from the reciprocal-space potential representation and then transformed back into physical space. For example, gx, gy, and gz components may be obtained by multiplying Phi_tilde(k) by corresponding reciprocal-space derivative factors and then applying one or more inverse transforms. Such derivative outputs may be useful in downstream contexts including orbital analysis, rotation-curve generation, inertial navigation compensation, geoid-gradient analysis, and simulation of object motion. However, the derivative branch is optional and need not be required in all implementations of the disclosed solver.

In preferred embodiments, the fixed kernel is realized using a lookup-memory architecture. Because the kernel depends only on the reciprocal-space magnitude |k|, the kernel may be represented as a radially indexed table rather than as a full multidimensional kernel storage structure. This radial dependence permits efficient storage and retrieval of kernel values while preserving application of the same fixed kernel across many reciprocal-space points having equal or substantially equal magnitude.

In one preferred implementation, the kernel is stored as a one-dimensional lookup table indexed by |k|. The lookup table may contain precomputed kernel values covering a reciprocal-space magnitude range associated with a selected grid size and computational domain. In selected embodiments, the table may be generated at synthesis time, compile time, initialization time, startup time, or another precompute stage, and thereafter reused during runtime solve operations. In this manner, the disclosed solver can avoid repeated recomputation of the kernel from floating-point power operations during each solve pass.

In one non-limiting example, a lookup structure may include 2048 entries with 64-bit values. Such a structure may be suitable for implementations in which the reciprocal-space magnitude range is discretized sufficiently to permit accurate interpolation while preserving compact memory footprint. Other table depths, precisions, or memory organizations may also be used, provided that the same fixed kernel is represented and applied.

In one example, a lookup structure having 2048 entries with 64-bit values corresponds to a total memory footprint of approximately 16 kB, making the fixed kernel suitable for compact memory realization in accelerated hardware platforms.

In selected embodiments, interpolation logic may be used between stored kernel values. For example, linear interpolation, cubic interpolation, spline interpolation, segmented interpolation, or other interpolation schemes may be employed. The interpolation scheme may be selected according to error tolerance, memory budget, target hardware resources, latency constraints, or desired implementation simplicity. Such interpolation logic does not alter the core fixed-kernel definition, but rather governs how stored kernel samples are mapped to intermediate reciprocal-space magnitudes.

In selected embodiments, interpolation accuracy may be selected such that kernel interpolation error remains below a target threshold, for example below 10∧−8 in a cubic interpolation implementation using a precomputed radial lookup table.

In preferred software and accelerator realizations, the disclosed solver may be implemented on one or more graphics processing units. In such embodiments, the input density representation may be stored in device-accessible memory, transformed using a GPU-executed transform engine, multiplied by the fixed kernel using one or more custom reciprocal-space kernels, and transformed back to physical space using one or more inverse transform operations. Memory staging, cache usage, buffer reuse, and thread or block assignment may be selected according to the target GPU architecture.

In selected GPU embodiments, a host processor may configure execution plans, allocate buffers, load or initialize lookup-memory kernel data, and dispatch one or more compute kernels. A transform library or equivalent transform engine may be used for forward and inverse transforms, while a separate multiply kernel may apply the fixed kernel values to the reciprocal-space density representation. In multi-device implementations, domain decomposition, partition exchange, or interconnect-assisted coordination may be used for grids larger than those conveniently handled by a single device.

In one preferred GPU realization, the reciprocal-space multiplication is executed using a custom compute kernel in which one or more threads are assigned to corresponding reciprocal-space points, while transform operations are executed using a GPU transform library. In selected embodiments, density data and kernel data are stored in global memory, and one or more cache structures are used to improve effective access performance during reciprocal-space multiplication.

In preferred hardware embodiments, the disclosed solver may be implemented on one or more field-programmable gate arrays. In such embodiments, an input stream or buffered density representation may be fed into a pipelined transform engine, kernel values may be retrieved from BRAM or other on-chip memory, reciprocal-space multiplication may be performed using dedicated arithmetic fabric such as DSP slices, and an inverse transform engine may return the result to physical space. Optional derivative units may also be included to compute one or more acceleration outputs.

In selected FPGA embodiments, the pipeline may be arranged for deterministic streaming operation. For example, an ingress interface may receive input density data, a forward pipelined FFT block may generate reciprocal-space samples, a kernel-memory block may provide corresponding fixed-kernel values, a multiply fabric may generate Phi_tilde(k), and an inverse FFT block may output Phi(r). In selected implementations, output data may then be streamed to memory, a host processor, an embedded control system, a navigation engine, or another downstream destination.

In one preferred FPGA realization, the transform engine comprises a pipelined radix-2 butterfly structure, the kernel memory comprises a BRAM-based lookup structure indexed by reciprocal-space magnitude, and the reciprocal-space multiplication is performed using dedicated arithmetic slices with pipeline latency selected according to the target clock frequency and throughput requirements.

By way of representative implementation examples, a GPU embodiment may solve a 128∧3 grid in approximately 4.3 ms, and an FPGA embodiment may solve a 128∧3 grid in approximately 8.7 ms. Such examples are illustrative implementation results and not claim limitations.

In selected embodiments, different numeric precision modes may be supported. For example, a single-precision path may be used where throughput or power efficiency is prioritized, while a double-precision path may be used where tighter numerical error control is desired. Precision selection may depend on application context, such as astrophysical modelling, geodesy, gravity anomaly analysis, or another environment in which differing numerical tolerances apply. Precision choice is therefore an implementation option and not a redefinition of the core fixed-kernel architecture.

In selected embodiments, execution modes may also be selected based on target deployment requirements. For example, one mode may prioritize throughput, another may prioritize latency, another may prioritize reduced power consumption, and another may prioritize numerical precision. Such control logic may be implemented through software configuration, hardware state control, or hybrid supervisory control. The core kernel and fixed parameter definitions remain unchanged across such operating modes.

In selected embodiments, the disclosed solver may be distributed across multiple compute devices. For example, one or more computational domains or subdomains may be partitioned across multiple GPUs, multiple FPGA regions, hybrid CPU-accelerator platforms, or distributed systems. Reciprocal-space or physical-space data exchange may then be performed between the participating devices as required. Such distributed execution may be beneficial for larger grid sizes or for environments requiring higher aggregate throughput. However, distribution of execution does not alter the identity of the disclosed fixed-kernel solver.

In addition to the preferred transform-domain implementation, alternative numerical engines may also be used while preserving the same fixed kernel. In one class of embodiments, the fixed kernel may be applied within a tree-code or multipole-style architecture. In another class of embodiments, the fixed kernel may be applied over one or more adaptive mesh levels in an adaptive mesh refinement environment. In another class of embodiments, the fixed kernel may be represented within a spectral-element or related basis expansion over non-Cartesian or irregular domains. In still other embodiments, a CPU-only or non-FFT reciprocal-space computational implementation may be used. These alternative embodiments preserve the same fixed kernel and are therefore alternative realizations of the same invention rather than separate inventions.

In selected embodiments, the disclosed solver may generate one or more output products. A primary output product is a gravitational potential field Phi(r). Optional output products include one or more gravitational acceleration component fields, combined vector acceleration fields, radial acceleration profiles, potential-derived scalar fields, or further processed fields used in downstream analysis. Output products may be stored in memory, written to file, transmitted over a network, provided to a visualization module, supplied to a control system, or otherwise made available to a downstream consumer.

In selected downstream environments, the disclosed solver may be used to generate modeled galaxy rotation curves from baryonic density inputs. In other downstream environments, the solver may be used to compute geoid-related potential outputs from gravity anomaly or satellite-derived input data. In other downstream environments, the solver may be used to generate local gravity compensation fields for inertial navigation or terrain-aware motion control. In still other downstream environments, the solver may be used for subsurface density interpretation, simulation of gravitational effects in virtual environments, spacecraft trajectory analysis, or related gravitational-field applications. Such uses are downstream deployments of the disclosed solver and do not redefine the core invention.

In selected embodiments, solver operation may be evaluated through one or more validation workflows. For example, a first validation workflow may compare generated rotation curves against observed velocity profiles for one or more galaxies. A second validation workflow may compare generated geoid or gravity-field outputs against a reference geodetic model. A third validation workflow may compare outputs across grid resolutions to evaluate convergence behavior. A fourth validation workflow may compare reduced-precision outputs against higher-precision outputs to assess numerical precision. A fifth validation workflow may assess interpolation error associated with lookup-table kernel retrieval. These validation flows support implementation quality and empirical assessment of the disclosed architecture.

In selected implementations, acceptance criteria may be defined for one or more validation tasks. For example, acceptance criteria may include a target residual level for rotation-curve comparison, a target residual level for geoid comparison, a target difference threshold across grid refinements, a target precision bound between single-and double-precision paths, or a target interpolation error bound for lookup-memory realization. Such acceptance criteria may guide solver qualification, deployment, or benchmarking. They are implementation and validation tools rather than limitations that define the inventive core.

In representative validation examples, the disclosed solver produced rotation-curve residuals below 3 percent for a disclosed set of THINGS survey galaxies, produced a geoid comparison residual of approximately 0.8 Gal RMS relative to EGM-2008, produced single-precision outputs with relative error below 10∧−6 relative to a double-precision reference, produced double-precision outputs with relative error below 10∧−12 relative to an arbitrary-precision reference, and produced lookup-table interpolation error below 10∧−8 in a representative cubic interpolation implementation. Such results are empirical outputs and validation results, not theoretical guarantees.

By way of example, a galaxy-rotation implementation may receive a baryonic density map, generate a reciprocal-space representation, apply the fixed kernel, recover gravitational potential and optionally radial acceleration, and derive a predicted velocity profile for comparison against observations. By way of further example, a geoid implementation may receive a gridded gravity anomaly representation, apply the same fixed-kernel solve sequence, and generate a geoid-related output for comparison against a reference geodetic model. By way of still further example, an inertial-navigation implementation may periodically update a local gravity field using the disclosed solver and use the resulting gravity estimate to compensate measured inertial data. These examples illustrate practical make-and-use operation of the disclosed architecture.

In one representative astrophysical example, a surface-density map corresponding to a galaxy in the THINGS survey was represented on a 128∧3 grid, processed using the disclosed fixed-kernel solver, and used to generate a circular-velocity profile from a derived radial acceleration field. In representative disclosed examples, the resulting modeled rotation curves remained within approximately 3 percent RMS of the observed values without invoking dark-matter halo parameters.

In one representative geodetic example, a gravity anomaly representation derived from satellite gravity data was processed using the disclosed solver on a 256∧3 grid to generate a geoid-related output. In a representative disclosed comparison against EGM-2008, the resulting residual was approximately 0.8 Gal RMS.

In selected embodiments, formal or machine-checked support may be used to confirm one or more properties of the disclosed solver architecture. Such support may confirm, for example, that the exponent is fixed at 5/12, that the softening quantity is given by k0=pi/phi, that k0=1/Xopt, that the kernel is positive for all reciprocal-space magnitudes, that the kernel is maximal at zero reciprocal-space magnitude, that the kernel-defining architecture is parameter-free, and that compact lookup-memory realization is available.

In further selected embodiments, formal support may also be used to confirm one or more implementation-oriented propositions, including representative throughput propositions for selected GPU and FPGA examples and compact-memory propositions associated with a pre-tabulated kernel realization. Such formal support does not change how the solver is practiced, but it may strengthen internal consistency, implementation traceability, and claim support.

In selected cosmological contexts, the disclosed solver may serve as a static gravitational component within a broader analysis environment. However, the present disclosure is directed to the static fixed-kernel solver architecture itself. To the extent a broader time-dependent or scale-dependent gravitational kernel is contemplated for full cosmological evolution, such an extension may employ additional structures beyond the static fixed-kernel architecture disclosed herein.

In this regard, the disclosed solver implements the static component of the gravitational modification architecture associated with the fixed Fourier-domain kernel K(k). To the extent full cosmological evolution is desired, additional time-dependent kernel structure may be used in a separate implementation or continuation disclosure.

It will be appreciated that numerous implementation details may vary without departing from the invention. Grid sizes, domain scales, memory formats, interpolation schemes, precision modes, transform libraries, arithmetic fabrics, scheduling strategies, interface standards, and deployment environments may differ across embodiments. What remains fixed across such embodiments is the use of the disclosed fixed softened fractional kernel, with exponent 5/12 and softening scale k0=pi/phi, to compute gravitational potential from mass density in a parameter-free solver architecture.

As used herein, the terms “engine,” “module,” “subsystem,” and “controller” refer to one or more of: (i) one or more processors executing stored instructions from memory, (ii) one or more programmable logic devices implementing the described operations, (iii) one or more dedicated hardware circuits, or (iv) combinations thereof, together with associated memory, buses, and interfaces configured to perform the recited functions.

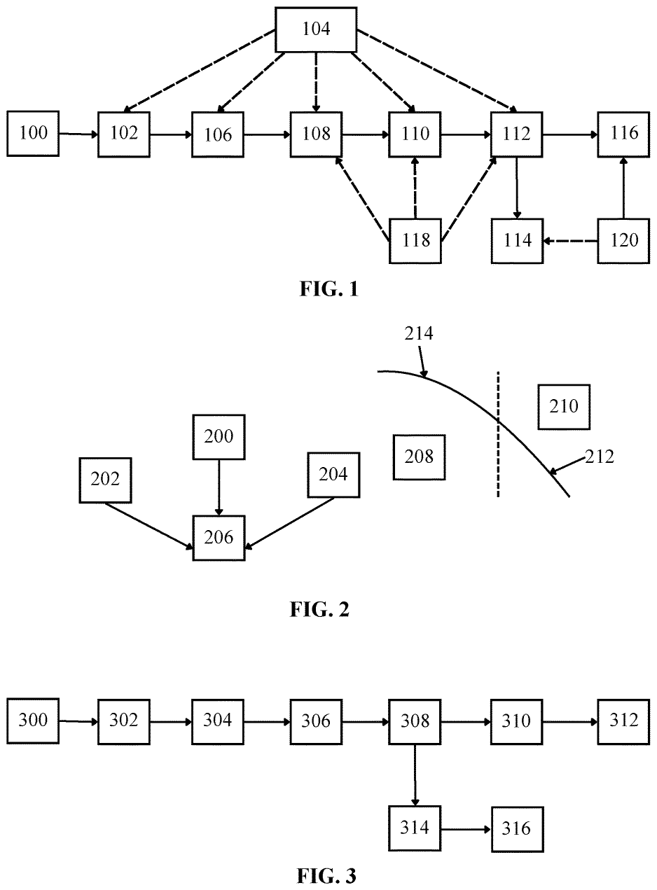

Referring now to FIG. 1, an overall gravity kernel solver architecture is illustrated. A mass-density input source 100 provides a density representation to an input interface 102. The input interface 102 may receive, buffer, validate, normalize, or otherwise prepare incoming density data for further processing. A solver controller 104 coordinates execution of the disclosed fixed-kernel gravitational solve, including control of transform operations, kernel retrieval operations, reciprocal-space multiplication, output generation, and optional derivative-output operations.

In the embodiment of FIG. 1, a forward transform engine 106 receives the input density representation and generates a reciprocal-space representation suitable for application of the fixed kernel. A fixed-kernel subsystem 108 stores, retrieves, generates from precomputed data, or otherwise provides the disclosed kernel values corresponding to reciprocal-space locations. A reciprocal-space multiply engine 110 applies the fixed kernel to the reciprocal-space density representation to generate a reciprocal-space potential representation. An inverse transform engine 112 then converts the reciprocal-space potential representation back into physical space to produce a gravitational potential output.

FIG. 1 further shows an optional derivative engine 114 coupled to the reciprocal-space or physical-space output path. The derivative engine 114 may compute one or more acceleration-related outputs derived from the gravitational potential. An output generator 116 may then format, store, transmit, stream, or otherwise provide one or more output products, including gravitational potential fields and optional derivative-based outputs. The illustrated architecture may further include a memory subsystem 118 and a compute platform 120. The memory subsystem 118 may include main memory, device memory, cache, lookup memory, or other storage structures used during solver execution. The compute platform 120 may include a CPU, GPU, FPGA, ASIC, embedded controller, multi-device platform, or hybrid computational environment.

FIG. 1 is intended to show the overall arrangement of the disclosed solver architecture rather than any one limiting hardware topology. In all such variations, the architecture remains centered on application of the same fixed softened fractional kernel with exponent 5/12 and softening scale k0=pi/phi.

Referring now to FIG. 2, the fixed kernel definition and its governing parameter relationships are illustrated. A fractional operator relation 200 represents the disclosed gravitational relation in operator form. A fixed exponent 202 identifies the exponent value 5/12. A fixed softening term 204 identifies the softening quantity k0=pi/phi. A Fourier-domain kernel 206 corresponds to the kernel K(k)=1/(|k|∧2+k0∧2)∧(5/12), which is the kernel that the solver implements.

FIG. 2 further illustrates representative kernel behavior. An IR-softened regime 208 identifies the low-|k|region in which the fixed softening term regularizes the kernel and prevents infrared divergence at zero reciprocal-space magnitude. A higher-|k|regime 210 identifies a region in which the kernel exhibits its corresponding fractional-order decay behavior. A positivity property 212 indicates that the kernel remains positive over the reciprocal-space domain of interest, while a finite-origin property 214 indicates that the kernel remains finite at |k|=0 because of the fixed softening term in the denominator.

FIG. 2 accordingly illustrates that the exponent and softening scale are not optional tuning quantities in the present disclosure. Rather, they are fixed and load-bearing elements of the disclosed solver architecture. The figure may be used to support both claim drafting and technical explanation of why the disclosed solver differs from generic fractional or softened gravity solvers that permit user selection or fitting of kernel-defining quantities.

Referring now to FIG. 3, a representative transform-domain computation workflow is shown. A density grid input 300 is received and passed to a normalization and setup stage 302. The setup stage 302 may include memory loading, reciprocal-space coordinate preparation, transform planning, buffer allocation, mode selection, or kernel-table initialization. A forward transform stage 304 then converts the density representation into reciprocal space.

A kernel retrieval stage 306 obtains kernel values corresponding to reciprocal-space locations or reciprocal-space magnitude values. In preferred embodiments, the kernel retrieval stage 306 retrieves values from a precomputed radial lookup structure. A pointwise multiply stage 308 then multiplies the reciprocal-space density representation by the fixed kernel to generate a reciprocal-space potential representation. An inverse transform stage 310 transforms the reciprocal-space potential back into physical space, and a potential output 312 is then produced.

FIG. 3 further illustrates an optional derivative branch 314. Where derivative outputs are desired, the derivative branch 314 may compute one or more reciprocal-space derivatives associated with gravitational acceleration and may then generate an acceleration output 316. The derivative branch 314 is optional and is not required in all embodiments. FIG. 3 thus provides a visual summary of the broad method concept disclosed herein.

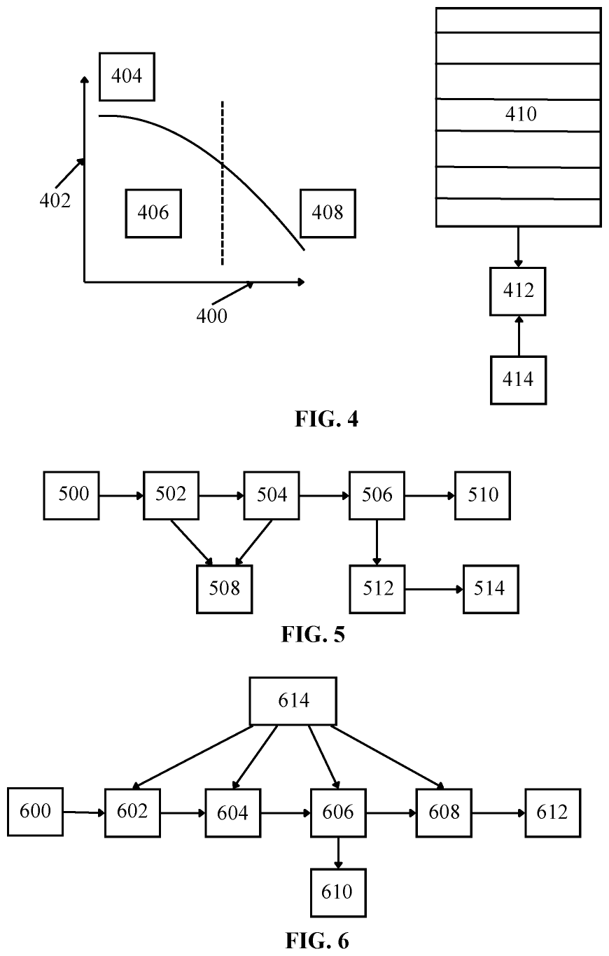

Referring now to FIG. 4, reciprocal-space kernel behavior and a lookup-memory realization are illustrated together. A |k|axis 400 and a kernel value axis 402 define a representative kernel profile. A zero-frequency point 404 identifies the value of the kernel at |k|=0, which remains finite due to the fixed softening term. A transition region 406 around k0 corresponds to the crossover between the low-|k|softened regime and the higher-|k|regime. A high-|k|tail 408 represents the decreasing fractional-order kernel behavior at larger reciprocal-space magnitude.

FIG. 4 further shows a lookup table 410, an interpolation engine 412, and a kernel memory 414. In preferred embodiments, the lookup table 410 stores radially indexed kernel values based on |k|. The interpolation engine 412 may interpolate between stored samples to provide values at intermediate reciprocal-space magnitudes. The kernel memory 414 may be implemented using one or more memory devices, lookup structures, ROM structures, BRAM structures, cache structures, or other storage resources depending on the selected platform. The arrangement shown in FIG. 4 is particularly suitable for compact and efficient realization of the fixed kernel in repeated gravitational solves.

Referring now to FIG. 5, a preferred GPU embodiment is illustrated. A host processor 500 coordinates the execution flow, including buffer allocation, transform configuration, kernel initialization, and output handling. Device memory 502 stores density data, reciprocal-space intermediate data, kernel data, output fields, or combinations thereof. A transform module 504 carries out forward and inverse transform operations on the GPU. A custom kernel multiply module 506 applies the disclosed fixed kernel to reciprocal-space density data.

FIG. 5 further illustrates a cache subsystem 508 and an output buffer 510. The cache subsystem 508 may cache lookup values, intermediate transform data, reciprocal-space blocks, or other runtime data to improve throughput. The output buffer 510 may temporarily store gravitational potential outputs or optional derivative-based outputs before transfer to host-accessible memory or another destination. In multi-device embodiments, a partition module 512 and interconnect 514 may be used to coordinate execution across multiple devices or device partitions.

The arrangement of FIG. 5 is illustrative of one preferred hardware realization in which the fixed kernel is applied efficiently using GPU-oriented transform and multiply operations. The specific programming framework, kernel launch topology, thread configuration, block layout, and memory placement may vary without departing from the invention.

Referring now to FIG. 6, a preferred FPGA embodiment is illustrated. An input stream 600 provides density data to a pipelined FFT engine 602. The FFT engine 602 produces reciprocal-space data in a form suitable for application of the fixed kernel. A kernel BRAM 604 stores kernel values, preferably in pre-tabulated form indexed by reciprocal-space magnitude or an equivalent mapping. A DSP multiply fabric 606 applies the fixed kernel to the reciprocal-space density representation.

FIG. 6 further shows an inverse FFT engine 608, an optional derivative unit 610, an output stream 612, and a clock and control block 614. The inverse FFT engine 608 returns the reciprocal-space potential representation to physical space. The optional derivative unit 610 may be included where acceleration outputs are desired. The output stream 612 may then transmit or store one or more result fields. The clock and control block 614 coordinates timing, buffering, data flow, and state transitions within the pipeline.

The FPGA realization of FIG. 6 is particularly suitable for implementations in which deterministic latency, dedicated arithmetic fabric, memory locality, or reduced power consumption are desirable. However, the invention is not limited to any one FPGA family, bus protocol, transform depth, or on-chip memory organization.

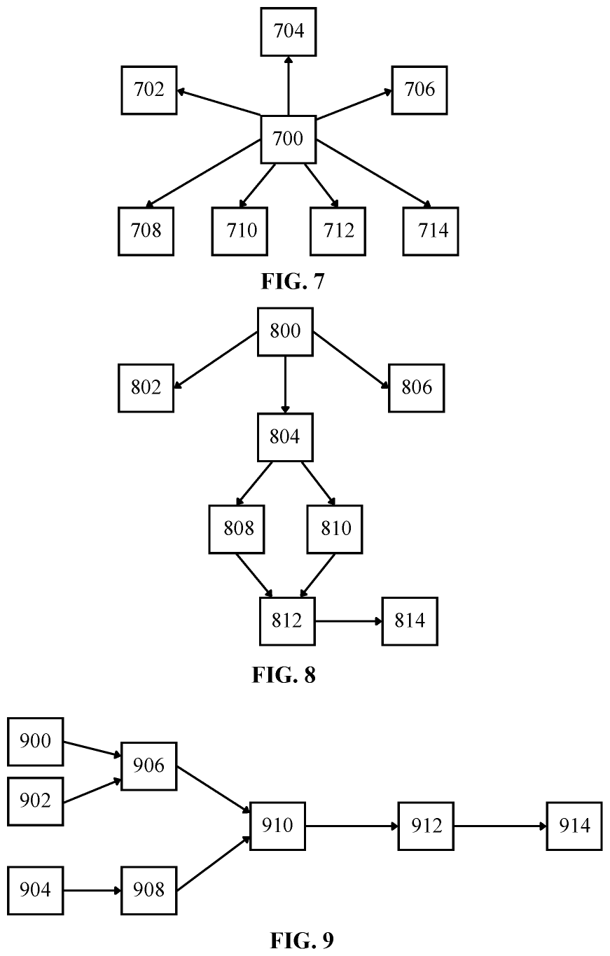

Referring now to FIG. 7, representative output products are illustrated. A potential field output 700 corresponds to the primary solver output. Optional acceleration outputs may include gx field output 702, gy field output 704, and gz field output 706. These outputs may be retained as full fields, downsampled, converted to profiles, or further processed according to the desired downstream use. FIG. 7 also shows representative downstream output generators including a rotation-curve generator 708, a geoid generator 710, a navigation compensation output 712, and a gravimetry output 714. These elements represent exemplary downstream products derived from the disclosed solver outputs. They are not required components of the core invention, but illustrate how the disclosed fixed-kernel solver may be integrated into broader computational workflows.

Referring now to FIG. 8, alternative numerical embodiments preserving the same fixed kernel are shown. A shared fixed-kernel block 800 represents the common kernel definition retained across the illustrated alternatives. A tree-code solver 802 may apply the fixed kernel in a hierarchical or multipole-style computation. An adaptive mesh refinement solver 804 may apply the same fixed kernel across one or more mesh levels. A spectral-element solver 806 may apply the same fixed kernel within a spectral basis or element-based representation.

FIG. 8 further shows a CPU realization 808 and a non-FFT reciprocal-space realization 810. The CPU realization 808 illustrates that the disclosed solver need not be limited to accelerator hardware. The non-FFT reciprocal-space realization 810 illustrates that the same fixed kernel may be used in reciprocal-space computational architectures other than the preferred FFT-based pipeline. A shared-output interface 812 and an embodiment selector 814 indicate that different numerical engines may be selected while preserving the same fixed-kernel gravitational computation.

The figure of FIG. 8 is intended to preserve support for alternative implementations without changing the core identity of the invention. The preferred implementation remains the transform-domain fixed-kernel pipeline. The alternatives of FIG. 8 remain subordinate embodiments of the same fixed-kernel solver architecture.

Referring now to FIG. 9, a validation and acceptance workflow is illustrated. A rotation-curve dataset 900, a geoid dataset 902, and a navigation test dataset 904 are shown as representative validation inputs. A convergence test module 906 may evaluate solver behavior across multiple grid sizes or discretization levels. A precision test module 908 may evaluate consistency across precision modes or against a higher-precision reference.

A residual calculator 910 may compute one or more residual values, error values, or comparison metrics. An acceptance evaluator 912 may compare such metrics to one or more target thresholds, acceptance criteria, or validation rules. A report generator 914 may then generate logs, benchmark summaries, deployment qualification outputs, validation certificates, or other implementation records.

In one example acceptance evaluation, the acceptance evaluator 912 determines that a rotation-curve validation passes when an RMS residual computed by the residual calculator 910 is less than 3 percent for at least a threshold count of datasets, and determines that a geoid validation passes when an RMS residual is less than 1 Gal relative to a reference model. In another example acceptance evaluation, the evaluator determines that a lookup-table interpolation validation passes when a maximum absolute kernel error is less than 1×10∧−8 over a tested |k|range and determines that a precision validation passes when a maximum relative output difference between a first precision mode and a second precision mode is less than 1×10∧−6.

FIG. 9 is not limited to any one benchmark dataset or any one acceptance threshold. Rather, it illustrates that the disclosed solver may be practically validated and benchmarked through structured workflows that assess rotation-curve comparison, geoid comparison, convergence, precision, interpolation, throughput, or other implementation characteristics.

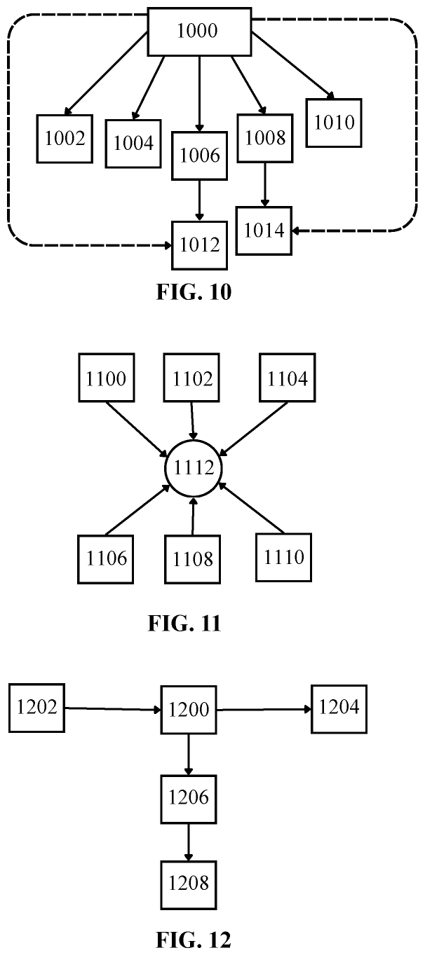

Referring now to FIG. 10, a formal-support and verification architecture is illustrated. A formalization module 1000 represents one or more machine-checked or formally verified support components associated with the disclosed solver. A fixed-exponent proof anchor 1002, fixed-softening proof anchor 1004, kernel-positivity proof anchor 1006, parameter-free proof anchor 1008, and throughput and ROM proof anchor 1010 represent exemplary formal support nodes corresponding to properties of the disclosed architecture.

FIG. 10 further shows a specification support node 1012 and a claim support node 1014. The specification support node 1012 indicates that formally supported properties may reinforce the coherence and technical explanation of the written disclosure. The claim support node 1014 indicates that such formal anchors may also strengthen support for claim drafting focused on fixed exponent, fixed softening, parameter-free architecture, compact lookup realization, or related solver characteristics. The presence of formal support does not redefine the invention, but may provide added implementation confidence and support leverage.

Referring now to FIG. 11, downstream deployment contexts are illustrated in consolidated form. A galaxy-modelling context 1100, a geodesy context 1102, an inertial-navigation context 1104, a spacecraft-navigation context 1106, a gravimetry context 1108, and a simulation context 1110 are shown as representative examples of environments in which the disclosed fixed-kernel solver may be used. A central grouping hub 1112 is shown schematically as a common deployment node indicating that each of the illustrated downstream contexts may receive outputs from, or be operationally associated with, the same disclosed fixed-kernel gravitational solver architecture.

The central grouping hub 1112 does not itself redefine the invention, but graphically indicates that the downstream contexts 1100, 1102, 1104, 1106, 1108, and 1110 are subordinate deployment environments coupled to a common solver architecture. In this manner, FIG. 11 preserves support for multiple use-oriented embodiments while maintaining the fixed-kernel gravitational solver as the inventive core.

The downstream deployment contexts of FIG. 11 are included to preserve implementation flexibility and support use-oriented embodiments. However, these contexts are not themselves the inventive core. The inventive core remains the fixed-kernel gravitational solver architecture that may be deployed into such environments.

Referring now to FIG. 12, a boundary is illustrated between the disclosed static fixed-kernel solver and future time-dependent extensions. A static fixed-kernel solver 1200 receives a baryonic density input 1202 and produces a static output path 1204 corresponding to gravitational potential and optional derivative outputs generated using the fixed kernel described herein. A time-dependent kernel branch 1206 is shown separately from the static solver path. A continuation boundary marker 1208 indicates that additional time-dependent or scale-dependent gravitational kernel structures may be pursued separately, but are not required to understand or practice the presently disclosed static fixed-kernel solver.

FIG. 12 is particularly useful in preserving claim discipline. The present disclosure is directed to the fixed static kernel solver architecture. To the extent broader time-dependent cosmological extensions are contemplated, those may be pursued as continuation subject matter without changing the identity of the presently disclosed invention.

The foregoing figure descriptions are illustrative and not limiting. The illustrated components may be combined, separated, reordered, omitted, duplicated, or otherwise rearranged in different embodiments. Likewise, one or more illustrated modules may be implemented in software, hardware, firmware, or hybrid form. What remains common across such embodiments is application of the fixed softened fractional kernel, with exponent 5/12 and softening scale k0=pi/phi, to compute gravitational potential from mass density in a parameter-free gravitational solver architecture.

What is claimed is:

1. A computer-implemented method for computing a gravitational potential, comprising:
receiving a mass-density representation over a computational domain;
transforming the mass-density representation into reciprocal space to obtain a reciprocal-space density representation;
applying to the reciprocal-space density representation a Fourier-domain kernel K(k)=1/(|k|∧2+k0∧2)∧(5/12), where k0=pi/phi and phi=(1+sqrt(5))/2; and
transforming the kernel-applied reciprocal-space density representation back into physical space to generate a gravitational potential field,
wherein the exponent 5/12 and the softening scale k0 are fixed and are not fitted to data.

2. The method of claim 1, wherein transforming the mass-density representation into reciprocal space comprises performing a forward Fourier transform, and transforming the kernel-applied reciprocal-space density representation back into physical space comprises performing an inverse Fourier transform.

3. The method of claim 1, wherein applying the Fourier-domain kernel comprises pointwise multiplication of the reciprocal-space density representation by the Fourier-domain kernel.

4. The method of claim 1, further comprising computing a reciprocal-space gravitational potential representation according to
Phi_tilde(k)=−4 pi G K(k) rho_tilde(k).

5. The method of claim 1, further comprising computing one or more components of gravitational acceleration from the gravitational potential field.

6. The method of claim 5, wherein computing the one or more components of gravitational acceleration comprises applying one or more spectral derivatives in reciprocal space and transforming one or more resulting derivative representations back into physical space.

7. The method of claim 1, wherein the Fourier-domain kernel is realized using a radially indexed lookup structure based on reciprocal-space magnitude |k|.

8. The method of claim 7, wherein the lookup structure comprises precomputed kernel values generated before runtime execution.

9. The method of claim 8, wherein the precomputed kernel values are generated at synthesis time, compile time, initialization time, or startup time.

10. The method of claim 7, wherein applying the Fourier-domain kernel includes interpolating between stored kernel values.

11. The method of claim 1, wherein the exponent 5/12 and the softening scale k0 are fixed as load-bearing kernel-defining quantities of the solver architecture and are not provided as runtime-selectable parameters, user-entered hyperparameters, or dataset-fitted model variables.

12. The method of claim 7, wherein the lookup structure stores kernel values as a one-dimensional radially indexed table based on reciprocal-space magnitude |k|, such that reciprocal-space points having equal or substantially equal magnitude reuse a common kernel value source.

13. The method of claim 1, wherein the fixed Fourier-domain kernel is applied in an alternative numerical engine selected from a tree-code solver, adaptive mesh refinement solver, spectral-element solver, CPU realization, or non-FFT reciprocal-space realization while preserving the same fixed exponent and fixed softening scale.

14. A system for computing a gravitational potential, comprising:
an input interface configured to receive a mass-density representation;
a transform engine configured to transform the mass-density representation into reciprocal space;
a fixed-kernel subsystem configured to provide a Fourier-domain kernel K(k)=1/(|k|∧2+k0∧2)∧(5/12), where k 0=pi/phi and phi=(1+sqrt(5))/2;
a reciprocal-space multiply engine configured to apply the Fourier-domain kernel to a reciprocal-space density representation; and
an inverse transform engine configured to generate a gravitational potential field from a kernel-applied reciprocal-space density representation,
wherein the exponent 5/12 and the softening scale k0 are fixed and are not fitted to data.

15. The system of claim 14, wherein the fixed-kernel subsystem comprises a lookup memory storing precomputed kernel values indexed by reciprocal-space magnitude |k|.

16. The system of claim 15, wherein the lookup memory comprises a ROM or BRAM structure.

17. The system of claim 14, further comprising a derivative engine configured to compute one or more gravitational acceleration outputs from the gravitational potential field.

18. The system of claim 14, wherein the system is implemented as a GPU-accelerated system, an FPGA-based system, an ASIC-based system, a CPU-based system, or a hybrid computing system.

19. A non-transitory computer-readable medium storing instructions that, when executed by one or more processors, cause the one or more processors to:
receive a mass-density representation;
transform the mass-density representation into reciprocal space;
apply a Fourier-domain kernel K(k)=1/(|k|∧2+k0∧2)∧(5/12), where k0=pi/phi and phi=(1+sqrt(5))/2; and
transform the kernel-applied reciprocal-space representation back into physical space to generate a gravitational potential field,
wherein the exponent 5/12 and the softening scale k0 are fixed and are not fitted to data.

20. The non-transitory computer-readable medium of claim 19, wherein the instructions further cause the one or more processors to compute one or more gravitational acceleration outputs from the gravitational potential field.
